(19) United States
(12) Patent Application Publication
(10) Pub. No.: US 2019/0091915 A1
(43) Pub. Date: Mar. 28, 2019

(54) A PROCESS FOR PREPARING HYDROGELS

(71) Applicant: STEER ENGINEERING PRIVATE LIMITED, Karnataka (IN)

(72) Inventors: Babu Padmanabhan, Bengaluru (IN); Robert Roden, Union Town, OH (US); Sambhu Bhadra, Karnataka (IN)

(21) Appl. No.: 15/767,742

(22) PCT Filed: Oct. 12, 2016
(86) PCT No.: PCT/IB16/56092

§ 371 Date: Apr. 12, 2018

(30) Foreign Application Priority Data
Oct. 13, 2015 (IN) 5483/CHE/2015

(51) Int. Cl. C08F 220/06; B29C 35/08; B29K 33/00

(52) U.S. Cl. CPC B29C 47/40; B29C 47/64; C08F 220/06; B29K 2033/08; B29C 2035/0855; B29K 2033/12; B29C 35/0805

(57) ABSTRACT

A process for preparing hydrogels is disclosed. Said process comprises passing reactants comprising a monomer, an initiator and a cross-linker through a co-rotating twin screw extruder, the co-rotating twin screw extruder being operated at a screw speed of at least 200 rpm and comprising an inlet zone, an outlet zone, and in between the inlet zone and the outlet zone at least one mixing zone, at least one conveying zone and at least one back-mixing zone, wherein the back-mixing zone comprises of restricting elements which restrict the reactants from moving forward in the co-rotating twin screw extruder until a forward force sufficient to overcome the restriction is achieved, such that the co-rotating twin screw extruder provides sufficient shear energy and residence time to the reactants to (co)polymerize and produce hydrogel having a water uptake greater than 100 g/g.

### FIELD OF INVENTION

The present disclosure relates to a process for preparing hydrogels. Particularly, the present disclosure relates to a process for preparing hydrogels by reactive extrusion.

### BACKGROUND

Hydrogels, or hydrophilic gels, are hydrophilic polymeric materials having a three dimensional cross-linked network capable of absorbing and holding large amounts of water. Owing to their hydrophilic properties, the hydrogels have good water interaction and swell when exposed to aqueous environment. Thus, it finds applications in hygienic products, agriculture, drug delivery systems, coal dewatering, food additives, pharmaceuticals, biomedical applications and tissue engineering and regenerative medicines and, diagnostics, wound dressing, separation of biomolecules or cells and barrier materials to regulate biological adhesions, and biosensor. Generally, hydrogels have a water uptake of nearly 10-20 times its molecular weight. Recently, superabsorbent hydrogels have been introduced, which have the ability to absorb water up to 100-1000 g/g (gram/gram) in aqueous environment. The size, porosity, hydrophilicity and crosslink density are the major factors that control the swelling rate and extent of the swelling of the hydrogel.

In general, hydrogels can be prepared from either synthetic polymers or natural polymers and are usually made of three ingredients, namely, monomer, initiator, and cross-linker. Any technique which can be used to create a cross-linked polymer can be used to produce a hydrogel.

Reactive extrusion is a known process for preparing hydrogels. Reactive extrusion involves causing a designed chemical reaction in a processor for modification or synthesis of a polymer. Reactive extrusion offers the advantages of being a continuous method; thus, it is desirable to produce hydrogels using reactive extrusion. However, the same is of limited or no utility as the water uptake of resultant hydrogels is usually less as compared to that obtainable by batch or semi-batch process. The resultant hydrogels thus have limited practical application. For example, U.S. Pat. Nos. 7,122,602 and 7,288,597 describe a reactive extrusion process for preparing polymeric hydrogel, particularly swellable in water, more than 100% (i.e. 1 g/g or equal to the weight of hydrogel) in 1 hour in aqueous media.

U.S. Pat. No. 7,795,359 discloses a continuous process for producing a polymeric material, including hydrogel, which comprises feeding the reactants into a flow-through polymerization reactor in a coil form, wherein the flow-through polymerization reactor is capable of providing a residence time sufficient for (co)polymerizing the reactants to form a (co)polymer with a desired polydispersity, wherein the flow-through polymerization reactor is immersed in an ultrasonic bath to minimize or substantially eliminate unwanted high-molecular-weight fractions of the (co)polymer. Said residence time is achieved by using the flow-through polymerization reactor having a length of 2 m to about 100 m.

There remains a need for a continuous process for preparing hydrogels having high water uptake. There is also a need for a continuous process for preparing hydrogels that does not exhibit the disadvantages associated with the prior known processes.

### SUMMARY

A process for preparing hydrogels is disclosed. Said process comprises passing reactants comprising a monomer, an initiator and a cross-linker through a co-rotating twin screw extruder, the co-rotating twin screw extruder being operated at a screw speed of at least 200 rpm and comprising an inlet zone, an outlet zone, and in between the inlet zone and the outlet zone at least one mixing zone, at least one conveying zone and at least one back-mixing zone, wherein the back-mixing zone comprises of restricting elements which restrict the reactants from moving forward in the co-rotating twin screw extruder until a forward force sufficient to overcome the restriction is achieved, such that the co-rotating twin screw extruder provides sufficient shear energy and residence time to the reactants to (co)polymerize and produce hydrogel having a water uptake greater than 100 g/g.

A co-rotating twin screw extruder for preparing hydrogels is also disclosed. Said extruder comprises an inlet zone for receiving one or more reactants, an outlet zone for recovering the hydrogel, a conveying zone for conveying the reactants, a mixing zone for homogenous mixing of the reactants, at least one back-mixing zone, the back-mixing zone comprising restricting elements selected from a group consisting of left hand elements, reverse elements and combinations thereof, wherein the restricting elements restrict the reactants from moving forward in the co-rotating twin screw extruder until a forward force sufficient to overcome the restriction is achieved.

An extruder assembly for preparing hydrogels is also disclosed. Said extruder assembly comprises: (a) a co-rotating twin screw extruder comprising an inlet zone for receiving one or more reactants, an outlet zone for recovering the hydrogel, a conveying zone for conveying the reactants, a mixing zone for homogenous mixing of the reactants, and at least one back-mixing zone, the back-mixing zone comprising restricting elements which restrict the reactants from moving forward in the co-rotating twin screw extruder until a forward force sufficient to overcome the restriction is achieved, the co-rotating twin screw extruder being configured to receive reactants comprising a monomer, an initiator and a cross-linker, and provide sufficient shear energy and residence time to the reactants to (co)polymerize and produce hydrogel having a water uptake greater than 100 g/g; and (b) a microwave source, the microwave source being configured to receive the hydrogel from the co-rotating twin screw extruder and expose said hydrogels to microwave energy to cause curing and drying thereof.

### DETAILED DESCRIPTION

In its broadest scope, the present disclosure relates to a process for preparing hydrogels by reactive extrusion. Specifically, disclosed process comprises passing reactants comprising a monomer, an initiator and a cross-linker through a co-rotating twin screw extruder, the co-rotating twin screw extruder being operated at a screw speed of at least 200 rpm and comprising an inlet zone, an outlet zone, and in between the inlet zone and the outlet zone at least one mixing zone, at least one conveying zone and at least one back-mixing zone, wherein the back-mixing zone comprises of restricting elements which restrict the reactants from moving forward in the co-rotating twin screw extruder until a forward force sufficient to overcome the restriction is achieved, such that the co-rotating twin screw extruder provides sufficient shear energy and residence time to the reactants to (co)polymerize and produce hydrogel having a water uptake greater than 100 g/g.

The shear energy and the residence time obtained due to the disclosed co-rotating twin screw extruder and the screw speed enhances the water uptake of the hydrogels as compared to that obtained by conventional reactive extrusion processes. Present disclosure addresses the problem of insufficient polymerization, encountered while preparing hydrogels by conventional process of reactive extrusion. Hydrogels obtained in accordance with the present disclosure have high water uptake and can be used as super absorbent hydrogels. The process of present disclosure can be employed to obtain hydrogels having wide range of water uptake. In particular, the process can be used to prepare hydrogels having a water uptake of upto 700 g/g.

Residence time in context of the present disclosure refers to the time spent by the reactants within the co-rotating twin screw extruder. In the disclosed process, the inventors have increased the residence time for reactive extrusion. In accordance with an embodiment, residence time has been increased by causing back-mixing of the reactants. Back-mixing is achieved by restricting the forward flow of reactants in a predetermined zone of the co-rotating twin screw extruder. Restricting the flow of reactants causes building up of the reactants in said zone of the extruder and thus provides a fresh supply of monomers to an initiated polymeric chain present in said zone. The building up continues until a forward force sufficient to overcome the restriction is achieved. Back-mixing thus increases the residence time of the reactants within the extruder. The back-mixing of the reactants can be carried out anywhere between an inlet and an outlet zone of the co-rotating twin screw extruder depending on the reactants.

Residence time required to prepare a hydrogel having specific water uptake can vary depending on the hydrogel. In accordance with an embodiment, the residence time of around 2-4 minutes is maintained in the co-rotating twin screw extruder. In accordance with a specific embodiment, residence time of at least 3 minutes is maintained in the co-rotating twin screw extruder.

Screw speed of at least 200 rpm is maintained in the co-rotating twin screw extruder. In accordance with an embodiment, the feed is subjected to a screw speed in a range of 200 to about 1500 rpm, and preferably 200 to 800 rpm. Said minimum screw speed provides the desired shear energy required for generating free radicals which could react with initiator. Providing sufficient shear energy for a sufficient residence time enables achieving the desired cross-linking and polymerization and hence water uptake.

In accordance with an embodiment, the reactants are maintained at a same temperature across the co-rotating twin screw extruder. In accordance with an embodiment, the reactants are maintained at a constant temperature in a range of 20-100° C. across the co-rotating twin screw extruder.

In accordance with an embodiment, a pre-mix of the reactants is prepared before passing the reactants through the co-rotating twin screw extruder. In accordance with an embodiment, the pre-mixing is carried out in a twin screw continuous mixer. The twin screw continuous mixer is connected in series with the co-rotating twin screw extruder, such that the reactants are pre-mixed in the twin screw continuous mixer and passed to the co-rotating twin screw extruder in a continuous manner. In accordance with a specific example, the twin screw continuous mixer is connected with the co-rotating twin screw extruder through a metallic hose. In accordance with an embodiment, a pre-mix is prepared by mixing one or more reactants in the twin screw continuous mixer. In accordance with an embodiment, when a hybrid hydrogel comprising a natural and a synthetic polymer is prepared, the natural polymer is denatured in the twin screw continuous mixer followed by addition of other reactants for preparing the pre-mix. In accordance with an embodiment, a pre-mix of one or more reactants is prepared in the twin screw continuous mixer and the remaining reactants are mixed with the pre-mix in the co-rotating twin screw extruder. Preferably, the monomer and the cross-linking agent are pre-mixed in the twin screw continuous mixer, and the initiator is mixed with the pre-mix in the co-rotating twin screw extruder. In accordance with an embodiment, the twin screw continuous mixer is a co-rotating twin screw extruder.

In accordance with an alternate embodiment, the reactants are fed directly to the co-rotating twin screw extruder. The reactants may be blended together or added separately in different zones of the extruder depending on the reactants. In accordance with an embodiment, the monomer and the cross-linker are added together in an inlet zone of the co-rotating twin screw extruder and the initiator is added in a zone between the inlet zone and the outlet zone through a feeder of the extruder.

In accordance with an embodiment, the process further comprises curing, purifying and drying the hydrogel obtained from the co-rotating twin screw extruder. Any conventional method of curing, purification and drying may be used.

In accordance with an embodiment, for purification of hydrogel, the cured hydrogel is subjected to a washing process utilizing either water or an organic solvent. Preferably, an initial water wash followed by washing with organic solvent is carried out. This additional process removes unreacted monomers and low molecular weight products, resulting in a final hydrogel product having faster and more efficient water uptake values. The purification step may be repeated in order to improve the water uptake of the hydrogel.

In accordance with an embodiment, one or both of curing and drying is carried out using microwave energy. It has been found by the present inventors that using microwave energy for curing and drying of hydrogel eliminates the requirement of an additional purification step in order to obtain hydrogel having higher water uptake. Microwave energy may be provided using any known microwave source. In accordance with an embodiment, curing and drying are carried out in a single step. In accordance with a preferred embodiment, curing and drying are carried out in separate steps. In accordance with an embodiment, the hydrogel obtained from the co-rotating twin screw extruder is exposed to microwaves in a microwave oven having an output in a range of 180-900 watts, and preferably 540 watts to effect curing. In accordance with a specific embodiment, the hydrogel obtained from the co-rotating twin screw extruder is exposed to microwaves at a frequency of 2450 MHz in a microwave oven having the output of 540 watts for 1.5 minutes to effect curing. The curing time depends on the reactants. Subsequent to curing, the hydrogel is exposed to microwave for drying thereof. In accordance with an embodiment, the hydrogel is dried in a controlled manner such that the hydrogel is not completely dried. Incomplete drying is critical for achieving hydrogel having higher water uptake. For controlled drying, the cured hydrogel is exposed to microwaves in a microwave oven having an output in a range of 180-900 watts, and preferably 540 watts. In accordance with a specific embodiment, the cured hydrogel is exposed to microwaves at a frequency of 2450 MHz in a microwave oven having an output of 540 watts for 1.5-3.0 minutes.

In accordance with an embodiment, the co-rotating twin screw extruder is connected in series with the microwave source through a conveying element, such that the preparation, curing and drying of the hydrogel are carried out in a fully continuous manner.

In accordance with an embodiment, the dried hydrogel is subjected to a grinding step. The hydrogel may be ground to form powder, beads, strands. Preferably, beads are formed.

The disclosed process can be applied to, without limitation, (co)polymerization reactions and free-radical chain (co)polymerization reactions. The teachings of the present disclosure can be applied to synthetic or hybrid hydrogels known in the art.

In accordance with an embodiment, the monomer(s) to be (co)polymerized is selected from a group consisting of methacrylic monomers, acrylic monomers, acrylamide monomer. Natural sources of polymer can be selected from a group consisting of proteins, cellulose, hemicelluloses and saccharides. In accordance with an embodiment, when natural sources of polymer are used, the natural source is subjected to a denaturation step prior to blending with other ingredients of the reactants. In accordance with an embodiment, the denaturation step is carried out in the twin screw continuous mixer.

In accordance with an embodiment, the initiator can be any persulfate or any other known radical initiator. In accordance with a related embodiment, the initiator is added in an amount in range of 0.7 to 1.0% w.r.t. to the total weight of the reactants, and preferably in an amount of 0.7%.

In accordance with an embodiment, the cross-linking agent is a tri-acrylate or any other known cross-linking agent. In accordance with a related embodiment, the cross-linking agent is added in an amount in range of 0.12 to 0.24% w.r.t. to the total weight of the reactants, and preferably in an amount of 0.12%.

In accordance with an embodiment, a radical accelerant may be optionally added to the reactants. Said radical accelerant may be any known radical accelerant. In accordance with a specific embodiment, the radical accelerant is sodium bisulfite.

In accordance with an embodiment, water may be optionally added to the reactants. In accordance with a related embodiment, water is added in an amount in range of 8.4-29.0% w.r.t. to the total weight of the reactants, and preferably in an amount of 8.4% w.r.t. to the total weight of the reactants.

A co-rotating twin screw extruder for preparing said hydrogels is also disclosed. Said extruder comprises of an inlet zone for receiving one or more reactants, an outlet zone for recovering the hydrogel, a conveying zone for conveying the reactants, a mixing zone for homogenous mixing of the reactants, at least one back-mixing zone, the back mixing zone comprising of restricting elements which restrict the reactants from moving forward in the co-rotating twin screw extruder until a forward force sufficient to overcome the restriction is achieved.

In accordance with an embodiment, the back-mixing zone comprises of restricting elements selected from a group consisting of left hand elements, reverse elements and combinations thereof. Said elements impart high compression and back pressure on to the reactants which restricts the flow of reactants and causes back-mixing thereof.

In accordance with an embodiment, additional back-mixing zones may be present in the co-rotating twin screw extruder. In accordance with an embodiment, the co-rotating twin screw extruder comprises of a first back-mixing zone and a second back-mixing zone. In accordance with an embodiment, the first and the second back-mixing zones are separated by at least one mixing zone or at least one conveying zone or a combination of at least of at least one mixing zone and at least one conveying zone. In accordance with an embodiment, the second back-mixing zone is proximate to the outlet zone.

In accordance with an embodiment, the co-rotating twin screw extruder has a Do/Di greater than 1.55 and is preferably 1.71. In accordance with an embodiment, the extruder has a length/diameter (L/D) ratio in a range of 40:1-60:1.

In accordance with an embodiment, the co-rotating twin screw extruder comprises one or more feeders for separate feeding of the different reactants into the extruder. The position of feeders depends on the reactants. In accordance with an embodiment, one or more feeders are located on the inlet zone, the conveying zone and/or the mixing zone.

In accordance with an embodiment, the inlet zone comprises of conveying elements to enable conveying the same forward.

In accordance with an embodiment, the conveying zone comprises of conveying elements.

In accordance with an embodiment, the reactants are conveyed to the mixing zone. As it is conveyed, the reactants are subjected to thorough mixing to obtain a homogeneous mass. In accordance with an embodiment, mixing zone comprises of mixing and reverse elements to enable uniform mixing of the reactants and to increase the residence time. In accordance with an embodiment, the mixing zone comprises of forward and neutral kneading elements. In accordance with an embodiment, the mixing zone comprises at least one fractional lobe element intermediate a first integer element (n) and a second integer element (N) {hereinafter referred to as a Fractional Mixing Element (FME)}. A fractional lobed element is an element intermediate a first integer element (n) and a second integer element (N) by a predefined fraction, such that N/n is an integer and the fraction determines the degree of transition between the first integer and the second integer. A single flight lobe and a bi-lobe can form fractional lobes such as 1.2.xx, where xx an be any number from 1 to 99. The numbers 1 to 99 define whether the fractional lobe will look more like a single flight element or a bi-lobed element. The numbers 1 and 2 in the notation 1.2.xx represent the lobe element intermediate a single flight element (1) and a bi-lobe element respectively (2). In accordance with an embodiment, the mixing zone further comprises at least one element having a continuous flight helically formed thereon having a lead ‘L’, wherein either the flight transforms at least once from an integer lobe flight into a non-integer lobe flight in a fraction of the lead ‘L’ and transforms back to an integer lobe flight in a fraction of the lead ‘L’ or the flight transforms at least once from a non-integer lobe flight to an integer lobe flight in a fraction of the lead ‘L’ and transforms back to an non-integer lobe flight in a fraction of the lead ‘L’ {hereinafter referred to as a Dynamic Stirring Element (DSE)}. This causes vigorous mixing of reacting molecules.

An extruder assembly for preparing hydrogels is also disclosed. Said assembly comprises above disclosed co-rotating twin screw extruder for preparation of the hydrogel and a microwave source for causing curing and drying of the obtained hydrogel.

The microwave source may be any known source, such as microwave oven. In accordance with an embodiment, the co-rotating twin screw extruder is connected in series with the microwave source through a conveying element such that preparation, curing and drying of hydrogel is carried out in a continuous manner. In accordance with a further embodiment, at least two microwave source are connected in series with the co-rotating twin screw extruder in order to first carry out the curing followed by drying of the hydrogel.

### EXAMPLES

### Example 1

### Preparation of Hybrid Hydrogel by Grafting of Acrylic Acid and Acrylamide to Soy Flour

Extruder specification: Omega-20P, Motor Power: 7.5 kW, Max Screw Speed: 1200 Rpm, Max Torque: 30 Nm/shaft, Specific Torque: 7.3 Nm/cm3, Barrel Diameter: 20 mm, Screw Diameter: 19.6 mm, L/D: 60, Do/Di: 1.71

TABLE 1
Screw Elements and Configuration

| Features | Screw type Configuration |
|---|---|
| Total no. of Barrels | 12 |
| Barrel Diameter | 20 mm |
| Length of Each Barrel | 100 mm |
| Element length | 1200 mm |
| Percentage of kneading | 48.76% |
| blocks | |
| Temperature of Barrels | B1-B12: 20° C. |

Screw Elements

| Element Number | Screw Element type |
|---|---|
| 1 | RSE 1515 1CHS |
| 2 | RSE 20/20 |
| 3-4 | RFV 40/40 |
| 5 | RFN 30/10 |
| 6 | RSE 20/20 |
| 7 | DSE A 20/40 A.B. |
| 8 | RSE 15/15 |
| 9-13 | RSE 10/10 |
| 14-15 | RKB 45/5/15 |
| 16--17 | NKB 90/5/15 |
| 18-19 | NKB 90/5/10 |
| 20 | LSE 15/10 |
| 21 | NKB 90/5/20 |
| 22 | RKB 45/5/20 |
| 23 | NKB 90/5/20 |
| 24 | RKB 45/5/20 |
| 25-27 | RKB 45/5/10 |
| 28 | LSE 30/15 |
| 29 | LSE 15/15 |
| 30 | RSE 15/15 |
| 31 | DSE A 20/40 A.B. |
| 32 | RKB 45/5/15 |
| 33 | NKB 90/5/15 |
| 34 | RKB 45/5/15 |
| 35 | NKB 90/5/15 |
| 36-37 | LSE 15/15 |
| 38-40 | RSE 30/30 |
| 41 | RSE 15/15 |
| 42-45 | RSE 10/10 |
| 46 | RKB 45/5/15 |
| 47 | NKB 90/5/15 |
| 48 | RKB 45/5/15 |
| 49 | NKB 90/5/15 |
| 50 | RSE 15/15 |
| 51 | RKB 45/5/15 |
| 52 | NKB 90/5/15 |
| 53 | RKB 45/5/15 |
| 54 | NKB 90/5/15 |
| 55 | RSE 15/15 |
| 56 | RKB 45/5/15 |
| 57 | NKB 90/5/15 |
| 58 | RKB 45/5/15 |
| 59 | NKB 90/5/15 |
| 60 | RSE 15/15 |
| 61 | RKB 45/5/15 |
| 62 | NKB 90/5/15 |
| 63 | RKB 45/5/15 |
| 64 | NKB 90/5/15 |
| 65 | RSE 15/15 |
| 66 | RKB 45/5/15 |
| 67 | NKB 90/5/15 |
| 68 | RKB 45/5/15 |
| 69 | NKB 90/5/15 |
| 70 | LSE 15/15 |
| 71 | LSE 15/15 |

List of Abbreviations for Elements

RSE: Right Handed Screw Element

RFV: Right Handed Shovel Element

RFN: Right Handed Transition Element

LSE: Left Handed Screw Element

DSE: Dynamic Stirring Element

RKB: 45 degree stagger angle Right Handed Kneading Block

NKB: 90 degree stagger angle (Neutral) Kneading Block

The back-mixing zones were formed at element 20, elements 28-29, elements 36-37 and elements 70-71.

Composition: The composition of the samples prepared have been listed in Table 2 and 3, below. Feed rate of the reactants are also stated in Table 2 and 3.

### Process:

All barrels were maintained at 20° C. and various experiments were performed by varying the screw speed between 200-800 rpm. Details of the experiments have been specified in Table 2 and 3. Soy flour was denatured with 30% Sodium hydroxide (NaOH). Denatured Soy flour was mixed with degassed water for 2 minutes, which was then mixed with Acrylic Acid/Trimethylopropane trimethacrylate (TMPTMA) for 5 minutes followed by mixing with Sodium bisulfite (NaBS) for 2 minutes to obtain “Premix A”. Premix A was fed to inlet barrel B1. “Premix B” was prepared by mixing APS with degassed water and was fed to barrel B7 using injection pump. The reactants were processed in the extruder as per the conditions specified in Table 1. Product obtained from outlet barrel was collected. With progress of time, product become little brownish and started solidifying. In one hour it became stable solid mass. The product was then kept overnight for curing. Next day it became a highly elastic solid mass. The hydrogel was then purified.

Purification: Purification was performed using the following two methods:

1. Method 1: This method comprises manually cutting the as-prepared hydrogel into small pieces which are then sonicated in water for 1 hour. Thus obtained hydrogel is then sonicated four times (every time for 10 minutes) using methanol. It is then dried in vacuum oven at 50° C.

2. Method 2: This method comprises manually cutting the as-prepared hydrogel into small pieces which are then stirred with methanol in a 10:1 volume/weight ratio for four hours. This was followed by heating recovered hydrogel (by sieving) in a vacuum oven at 50° C. overnight.

Water absorption study: To calculate the water uptake value of the hydrogel, three replicates of as formed hydrogel were removed and vacuum dried to constant weight followed by grinding to about 210 -250 μm particle size. 0.3 g of vacuum dried hydrogel was weighed in a 200 mL plastic container and covered with distilled water. Gel was allowed to swell overnight. Swollen gel was checked for signs of excess water. If water was not found excess, more water was added and the gel was allowed to continue to swell. If excess water was present, swollen gel was transferred to a tarred #35 S.S. sieve and excess water was drained. Paper towel was used to wick excess water from the bottom of the sieve. The sieve and the swollen gel were weighed. Subtracted the tare weight of the sieve and recorded the weight of the swollen gel. Subtracted the weight of the original vacuum dried gel from the weight of the swollen gel and divided that value by the original dried gel weight and recorded this as the water uptake value.

Experiment 1: The composition and the water uptake ratio of the hydrogels obtained as a result of the disclosed process have been tabulated in Table 2.

TABLE 2
Composition and water uptake ratio of hydrogel

| | Composition | | Premix-A | Premix-B |
|---|---|---|---|---|
| Material | % | kg | kg | kg |
| Soy | 14.86 | 0.530 | 0.530 | — |
| Sodium bisulfite | 0.85 | 0.0302 | 0.0302 | — |
| (NaBS) | | | | |
| 30% Sodium hydroxide | 43.58 | 1.554 | 1.554 | — |
| H₂O | 8.41 | 0.300 | | 0.300 |
| Acrylic acid | 31.27 | 1.115 | 1.115 | — |
| TMPTMA | 0.15 | 0.0054 | 0.0054 | — |
| Ammonium persulfate | 0.86 | 0.0308 | — | 0.0308 |
| (APS) | | | | |

| | | | |
|---|---|---|---|
| APS to NaBS ratio | 1.02 | | |
| Feed rate (kg/h) | | 3.2346 | 0.3308 |
| Feed rate (g/min) | | 53.9 | 5.5 |

| | Screw speed | |
|---|---|---|
| Sample ID | (rpm) | Water uptake |
| S1 | 200 | 226 |
| S2 | 800 | 241 |

It was observed that increasing the screw speed resulted in increasing the water uptake of the resultant hydrogel.

Experiment 2: The composition and the water uptake ratio of the hydrogels obtained as a result of the disclosed process have been tabulated in Table 3.

TABLE 3
Composition and water uptake ratio of hydrogel

| | Composition | | Premix-A | Premix-B |
|---|---|---|---|---|
| Material | % | kg | kg | kg |
| Soy | 12.11 | 0.530 | 0.530 | — |
| 30% Sodium hydroxide | 32.00 | 1.400 | 1.400 | — |
| H₂O | 29.10 | 1.273 | 0.973 | 0.300 |
| Acrylic acid | 21.93 | 0.9593 | 0.9593 | — |
| Acrylamide | 3.56 | 0.1557 | 0.1557 | — |
| TMPTMA | 0.12 | 0.0054 | 0.0054 | — |
| Sodium bisulfite | 0.47 | 0.0205 | 0.0205 | — |
| Ammonium persulfate | 0.70 | 0.0308 | — | 0.0308 |
| Feed rate (kg/h) | | | 4.0439 | 0.3308 |
| Feed rate (g/min) | | | 67.4 | 5.5 |

| | Screw speed | |
|---|---|---|
| Sample ID | (rpm) | Water uptake |
| T1 | 800 | 719^{a} |
| | | 241^{b} |
| | | 238^{c} |

^{a}Purified by Method 1
^{b}Purified by Method 2
^{c}As prepared (without purification)

It was observed that the water uptake of the hydrogel improved upon purification. It was further observed that purification using above-disclosed method 1 resulted in hydrogel having higher water uptake as compared to that obtained using method 2.

### Example 2

### Preparation of Hybrid Hydrogel by Grafting of Acrylic Acid and Acrylamide to Soy Flour

Specification of Extruder 1: Omega-20P, Motor Power: 7.5 kW, Max Screw Speed: 1200 Rpm, Max Torque: 30 Nm/shaft, Specific Torque: 7.3 Nm/cm3, Barrel Diameter: 20 mm, Screw Diameter: 19.6 mm, L/D: 60, Do/Di: 1.71

TABLE 4
Screw Elements and Configuration

| Features | Screw type Configuration |
|---|---|
| Total no. of Barrels | 12 |
| Barrel Diameter | 20 mm |
| Length of Each Barrel | 100 mm |
| Element length | 1200 mm |
| Percentage of kneading | 44.8% |
| blocks | |
| Temperature of Barrels | B2-B6: 70° C., B7-B12: 20° C. |

Screw Elements

| Element Number | Screw Element type |
|---|---|
| 1 | RSE 15/15 1CHS |
| 2-3 | RFV 45/45 |
| 4-5 | RFV 40/40 |
| 6 | RFN 30/15 |
| 7 | RSE 30/30 |
| 8-9 | RSE 20/20 |
| 10 | DSE A 20/40 A.B. |
| 11 | RSE 15/15 |
| 12-16 | RSE 10/10 |
| 17-18 | RKB 45/5/20 |
| 19-20 | NKB 90/5/20 |
| 21 | RKB 45/5/20 |
| 22 | NKB 90/5/20 |
| 23 | RSE 15/15 |
| 24 | RKB 45/5/15 |
| 25 | NKB 90/5/15 |
| 26 | RKB 45/5/15 |
| 27 | NKB 90/5/15 |
| 28-29 | NKB 90/5/150 |
| 30 | RSE 15/15 |
| 31 | RKB 45/5/15 |
| 32 | NKB 90/5/15 |
| 33 | RKB 45/5/15 |
| 34 | NKB 90/5/15 |
| 35 | DSE A. 20/40 A.B |
| 36 | FKB 90/7/30 |
| 37 | RKB 45/5/15 |
| 38 | NKB 90/5/15 |
| 39-40 | RKB 45/5/10 |
| 41 | LSE 20/10 |
| 42 | LSE 15/15 |
| 43-45 | RSE 30/30 |
| 46 | RSE 20/20 |
| 47 | RSE 15/15 |
| 48-49 | RSE 10/10 |
| 50 | RKB 45/5/15 |
| 51 | NKB 90/5/15 |
| 52 | RKB 45/5/15 |
| 53 | NKB 90/5/15 |
| 54 | RSE 15/15 |
| 55 | RKB 45/5/15 |
| 56 | NKB 90/5/15 |
| 57 | RKB 45/5/15 |
| 58 | NKB 90/5/15 |
| 59 | RSE 15/15 |
| 60 | RKB 45/5/20 |
| 61 | NKB 90/5/20 |
| 62 | RKB 45/5/15 |
| 63 | NKB 90/5/15 |
| 64 | RKB 45/5/10 |
| 65 | RSE 15/15 |

The back-mixing zones were formed at elements 41-42.

Specification of Extruder 2: Omega-20P, Motor Power: 7.5 kW, Max Screw Speed: 1200 Rpm, Max Torque: 30 Nm/shaft, Specific Torque: 7.3 Nm/cm3, Barrel Diameter: 20 mm, Screw Diameter: 19.6 mm, L/D: 60, Do/Di: 1.71

TABLE 5
Screw Elements and Configuration

| Features | Screw type Configuration |
|---|---|
| Total no. of Barrels | 10 |
| Barrel Diameter | 30 mm |
| Length of Each Barrel | 180 mm |
| Element length | 1800 mm |
| Percentage of kneading | 53.44% |
| blocks | |
| Temperature of Barrels | B1-B12: 20° C. |

Screw Elements

| Element Number | Screw Element type |
|---|---|
| 1 | RSE 20/20 1CHS |
| 2 | RSE 40/40 |
| 3 | SKE 60/60 |
| 4 | SKE 40/40 |
| 5 | SKN 40/20 |
| 6 | RSE 40/40 |
| 7 | DSE A. 30/60 A.B. |
| 8 | RSE 15/30 |
| 9-10 | RSE 10/30 |
| 11-12 | RKB 45/5/30 |
| 13-15 | NKB 90/5/40 |
| 16 | RSE 15/30 |
| 17 | NKB 90/5/40 |
| 18-19 | FKB 90/7/30 |
| 20 | RKB 45/5/20 |
| 21-22 | RKB 45/5/15 |
| 23 | LSE 30/15 |
| 24 | LSE 20/20 |
| 25 | RSE 30/30 |
| 26 | DSE A 30/60 A.B. |
| 27 | RKB 45/5/20 |
| 28 | NKB 90/5/20 |
| 29 | RKB 45/5/20 |
| 30 | NKB 90/5/20 |
| 31 | RKB 45/5/20 |
| 32 | NKB 90/5/20 |
| 33 | DSE A 30/60 A.B. |
| 34-35 | RSE 20/20 |
| 36 | RKB 45/5/15 |
| 37 | NKB 90/5/15 |
| 38 | RKB 45/5/15 |
| 39 | NKB 90/5/15 |
| 40 | RSE 20/20 |
| 41 | RKB 45/5/15 |
| 42 | NKB 90/5/15 |
| 43 | RKB 45/5/15 |
| 44 | NKB 90/5/15 |
| 45 | RSE 20/20 |
| 46 | RKB 45/5/20 |
| 47 | NKB 90/5/20 |
| 48 | RKB 45/5/20 |
| 49 | NKB 90/5/20 |
| 50 | RSE 20/20 |
| 51 | RKB 45/5/20 |
| 52 | NKB 90/5/20 |
| 53 | RKB 45/5/20 |
| 54 | NKB 90/5/20 |
| 55 | RSE 20/20 |
| 56 | RKB 45/5/20 |
| 57 | NKB 90/5/20 |
| 58 | RKB 45/5/20 |
| 59 | NKB 90/5/20 |
| 60 | RSE 20/20 |
| 61 | RKB 45/5/20 |
| 62 | NKB 90/5/20 |
| 63 | RKB 45/5/20 |
| 64 | NKB 90/5/20 |
| 65 | RSE 20/20 |
| 66 | RKB 45/5/20 |
| 67 | NKB 90/5/20 |
| 68 | RKB 45/5/20 |
| 69 | NKB 90/5/20 |
| 70-74 | RSE 20/20 |

The back-mixing zones were formed at elements 23-24.

List of Abbreviations for Elements

RSE: Right Handed Screw Element

RFV: Right Handed Shovel Element

RFN: Right Handed Transition Element

LSE: Left Handed Screw Element

DSE: Dynamic Stirring Element

RKB: 45 degree stagger angle Right Handed Kneading Block

NKB: 90 degree stagger angle (Neutral) Kneading Block

SKE: Schubkanten Elements

SKN: Transition Element for SKE

FKB: Fractional Lobe Kneading Block

Composition: The composition of the samples prepared has been listed in Table 6, below. Feed rate of the reactants are also stated in Table 6.

TABLE 6
Composition of the hydrogel

| | Composition | | Premix-A | Premix-B |
|---|---|---|---|---|
| Material | % | kg | kg | kg |
| Soy | 15.6 | 1.060 | 1.060 | — |
| 30% Sodium hydroxide | 41.2 | 2.800 | 2.800 | — |
| H₂O | 8.8 | 0.600 | — | 0.600 |
| Acrylic acid | 28.2 | 1.9186 | 1.9186 | — |
| Acrylamide | 4.6 | 0.3114 | 0.3114 | — |
| TMPTMA | 0.15 | 0.010 | 0.011 | — |
| Sodium bisulfite | 0.60 | 0.0410 | 0.0410 | — |
| Ammonium persulfate | 0.9 | 0.0616 | — | 0.0308 |
| Feed rate (kg/h) | | | 6.142 | 0.6308 |
| Feed rate (g/min) | | | 102.4 | 10.5 |
| Screw Speed (RPM) | | | 600 | 70 |

Process: Two extruders-Extruders 1 and 2 were connected in series. In the Extruder 1, Soy flour was denatured with 30% Sodium hydroxide (NaOH). To this reaction mixture, Acrylic Acid, Acrylamide, Trimethylopropane trimethacrylate (TMPTMA) were added followed by addition of Sodium bisulfite (NaBS) to obtain “Premix A”. Premix A was fed in a continuous manner to barrel B1 of Extruder 2. Ammonium persulfate was added to the Premix-A in barrel B2 of Extruder 2 using injection pump. The reactants were processed in the Extruders 1 and 2 as per the conditions specified in Table 4 and 5 respectively. Product obtained from outlet barrel was collected.

The moisture content of the hydrogel thus obtained was measured and the hydrogel was subjected to controlled drying using different methods. The water uptake capacity of the hydrogel upon drying has been enlisted in Table 7, below.

TABLE 7
Water Uptake of Resultant Hydrogel

| Moisture | | | Drying | |
|---|---|---|---|---|
| content (%) | Drying method | Drying time | temperature | Water uptake |
| 32 | Vacuum Oven | 10 hours | 55° C. | 183 |
| | Hot Air Oven | 3 hours | 120° C. | 138 |
| | Microwave | 1.5 minutes | — | 223 |
| | Oven | | | |

It was observed that controlled drying using microwave energy resulted in obtaining hydrogel having highest water uptake as compared to other methods.

### INDUSTRIAL APPLICABILITY

The present disclosure provides an improved process of reactive extrusion for preparing hydrogels. Disclosed process is safe, easy and inexpensive to operate as it does not require a new machine or system for operation, but existing machines and equipment in an improved manner.

The process can be applied to obtain both synthetic and hybrid hydrogel. The process can be used to prepare hydrogels having a water uptake of upto 700 g/g. The hydrogels obtained using disclosed process can be used as super absorbent hydrogels.

The process not only results in obtaining hydrogels having high water uptake but also provides the benefits of a continuous process. Using the disclosed process, the hydrogels can be prepared using an entirely continuous process while reducing the total time for preparing hydrogels to a minimum of 10-12 minutes.

The disclosed process does not require high temperatures and can be carried out at significantly lower temperatures as compared to the conventional processes. The disclosed process is thus energy efficient.

The obtained hydrogel has advantageous swelling properties in various solvent media such as water, base, salt, buffers, etc. The hydrogel obtained using the disclosed process finds application in pharmaceutical, agricultural, cosmetic, detergent and other industries.

### Specific Embodiments are Described Below

A process for preparing hydrogels, the process comprising passing reactants comprising a monomer, an initiator and a cross-linker through a co-rotating twin screw extruder, the co-rotating twin screw extruder being operated at a screw speed of at least 200 rpm and comprising an inlet zone, an outlet zone, and in between the inlet zone and the outlet zone at least one mixing zone, at least one conveying zone and at least one back-mixing zone, wherein the back-mixing zone comprises of restricting elements which restrict the reactants from moving forward in the co-rotating twin screw extruder until a forward force sufficient to overcome the restriction is achieved, such that the co-rotating twin screw extruder provides sufficient shear energy and residence time to the reactants to (co)polymerize and produce hydrogel having a water uptake greater than 100 g/g before purification.

Such process(es) wherein the restricting elements are selected from a group consisting of left hand elements, reverse elements and combinations thereof.

Such process(es) wherein the back-mixing zone is preceded by the mixing zone, the mixing zone comprising at least one of an element comprising a continuous flight helically formed thereon having a lead ‘L’, wherein either the flight transforms at least once from an integer lobe flight into a non-integer lobe flight in a fraction of the lead ‘L’ and transforms back to an integer lobe flight in a fraction of the lead ‘L’ or the flight transforms at least once from a non-integer lobe flight to an integer lobe flight in a fraction of the lead ‘L’ and transforms back to an non-integer lobe flight in a fraction of the lead ‘L’ , and fractional lobe element intermediate a first integer element (n) and a second integer element (N).

Such process(es) wherein the co-rotating twin screw extruder is operated at the screw speed in a range of 200-1500 rpm.

Such process(es) wherein the back-mixing zone is proximate to the outlet zone.

Such process(es) wherein the reactants before being passed through the co-rotating twin screw extruder are mixed in a continuous manner in a twin screw continuous mixer, the twin screw continuous mixer being connected in series with the co-rotating twin screw extruder.

Such process(es), further comprising subjecting the hydrogel obtained from the co-rotating twin screw extruder to curing followed by controlled drying.

Such process(es) wherein one or both of the curing and controlled drying is carried out using microwave energy.

A co-rotating twin screw extruder for preparing hydrogels comprising an inlet zone for receiving one or more reactants, an outlet zone for recovering the hydrogel, a conveying zone for conveying the reactants, a mixing zone for homogenous mixing of the reactants, at least one back-mixing zone, the back-mixing zone comprising restricting elements selected from a group consisting of left hand elements, reverse elements and combinations thereof, wherein the restricting elements restrict the reactants from moving forward in the co-rotating twin screw extruder until a forward force sufficient to overcome the restriction is achieved.

Such extruder(s) comprising a first back-mixing zone, a second back mixing zone, wherein the first and the second back-mixing zones are separated by at least one mixing zone or at least one conveying zone or a combination of at least of at least one mixing zone and at least one conveying zone, and the second back-mixing zone is proximate to the outlet zone.

Such extruder(s) wherein the mixing zone comprises at least one of an element comprising a continuous flight helically formed thereon having a lead ‘L’, wherein either the flight transforms at least once from an integer lobe flight into a non-integer lobe flight in a fraction of the lead ‘L’ and transforms back to an integer lobe flight in a fraction of the lead ‘L’ or the flight transforms at least once from a non-integer lobe flight to an integer lobe flight in a fraction of the lead ‘L’ and transforms back to an non-integer lobe flight in a fraction of the lead ‘L’, and fractional lobe element intermediate a first integer element (n) and a second integer element (N).

Such extruder(s) wherein the co-rotating twin screw extruder has a Length/Diameter (L/D) ratio in a range of 40:1-60:1.

An extruder assembly for preparing hydrogels comprising: (a) a co-rotating twin screw extruder comprising an inlet zone for receiving one or more reactants, an outlet zone for recovering the hydrogel, a conveying zone for conveying the reactants, a mixing zone for homogenous mixing of the reactants, and at least one back-mixing zone, the back-mixing zone comprising restricting elements which restrict the reactants from moving forward in the co-rotating twin screw extruder until a forward force sufficient to overcome the restriction is achieved, the co-rotating twin screw extruder being configured to receive reactants comprising a monomer, an initiator and a cross-linker and provide sufficient shear energy and residence time to the reactants to (co)polymerize and produce hydrogel having a water uptake greater than 100 g/g; and (b) a microwave source, the microwave source being configured to receive the hydrogel from the co-rotating twin screw extruder and expose said hydrogels to microwave energy to cause curing and drying thereof.

1. A process for preparing hydrogels, the process comprising:
passing reactants comprising a monomer, an initiator and a cross-linker through a co-rotating twin screw extruder, the co-rotating twin screw extruder being operated at a screw speed of at least 200 rpm and comprising an inlet zone, an outlet zone, and in between the inlet zone and the outlet zone at least one mixing zone, at least one conveying zone and at least one back-mixing zone, wherein the back-mixing zone comprises of restricting elements which restrict the reactants from moving forward in the co-rotating twin screw extruder until a forward force sufficient to overcome the restriction is achieved, such that the co-rotating twin screw extruder provides sufficient shear energy and residence time to the reactants to (co)polymerize and produce hydrogel having a water uptake greater than 100 g/g before purification.

2. The process as claimed in claim 1, wherein the restricting elements are selected from a group consisting of left hand elements, reverse elements and combinations thereof.

3. The process as claimed in claim 1, wherein the back-mixing zone is preceded by the mixing zone, the mixing zone comprising at least one of an element comprising a continuous flight helically formed thereon having a lead ‘L’, wherein either the flight transforms at least once from an integer lobe flight into a non-integer lobe flight in a fraction of the lead ‘L’ and transforms back to an integer lobe flight in a fraction of the lead ‘L’ or the flight transforms at least once from a non-integer lobe flight to an integer lobe flight in a fraction of the lead ‘L’ and transforms back to an non-integer lobe flight in a fraction of the lead ‘L’, and a fractional lobe element intermediate a first integer element (n) and a second integer element (N).

4. The process as claimed in claim 1, wherein the co-rotating twin screw extruder is operated at the screw speed in a range of 200-1500 rpm.

5. The process as claimed in claim 1, wherein the back-mixing zone is proximate to the outlet zone.

6. The process as claimed in claim 1, wherein the reactants before being passed through the co-rotating twin screw extruder are mixed in a continuous manner in a twin screw continuous mixer, the twin screw continuous mixer being connected in series with the co-rotating twin screw extruder.

7. The process as claimed in claim 1, further comprising subjecting the hydrogel obtained from the co-rotating twin screw extruder to curing followed by controlled drying.

8. The process as claimed in claim 7, wherein one or both of the curing and controlled drying is carried out using microwave energy.

9. A co-rotating twin screw extruder for preparing hydrogels comprising:
an inlet zone for receiving one or more reactants,
an outlet zone for recovering the hydrogel,
a conveying zone for conveying the reactants,
a mixing zone for homogenous mixing of the reactants, and
at least one back-mixing zone, the back-mixing zone comprising restricting elements selected from a group consisting of left hand elements, reverse elements and combinations thereof, wherein the restricting elements restrict the reactants from moving forward in the co-rotating twin screw extruder until a forward force sufficient to overcome the restriction is achieved.

10. The extruder as claimed in claim 9 comprising:
a first back-mixing zone, and
a second back mixing zone,
wherein the first and the second back-mixing zones are separated by at least one mixing zone or at least one conveying zone or a combination of at least of at least one mixing zone and at least one conveying zone, and the second back-mixing zone is proximate to the outlet zone.

11. The extruder as claimed in claim 9, wherein the at least one back-mixing zone is preceded by the mixing zone, the mixing zone comprising at least one of an element comprising a continuous flight helically formed thereon having a lead ‘L’, wherein either the flight transforms at least once from an integer lobe flight into a non-integer lobe flight in a fraction of the lead ‘L’ and transforms back to an integer lobe flight in a fraction of the lead ‘L’ or the flight transforms at least once from a non-integer lobe flight to an integer lobe flight in a fraction of the lead ‘L’ and transforms back to an non-integer lobe flight in a fraction of the lead ‘L’, and a fractional lobe element intermediate a first integer element (n) and a second integer element (N).

12. The extruder as claimed in claim 9, wherein the co-rotating twin screw extruder has a Length/Diameter (L/D) ratio in a range of 40:1-60:1.

13. (canceled)

14. The extruder as claimed in claim 9, further including a microwave source, the microwave source being configured to receive the hydrogel from the co-rotating twin screw extruder and expose said hydrogels to microwave energy to cause curing and drying thereof.

15. A process for preparing hydrogels, the process comprising:
passing reactants comprising a monomer, an initiator and a cross-linker through a co-rotating twin screw extruder, the co-rotating twin screw extruder being operated at a screw speed of at least 200 rpm and comprising an inlet zone, an outlet zone, and in between the inlet zone and the outlet zone at least one mixing zone, at least one conveying zone and at least one back-mixing zone, wherein the back-mixing zone comprises of restricting elements which restrict the reactants from moving forward in the co-rotating twin screw extruder until a forward force sufficient to overcome the restriction is achieved,
such that the co-rotating twin screw extruder provides sufficient shear energy and residence time to the reactants to (co)polymerize and produce hydrogel having a water uptake greater than 100 g/g before purification, and
purifying the hydrogel by sonicating in water before sonicating at least once in methanol.

16. The process as claimed in claim 14, wherein the residence time of at least 3 minutes is maintained in the co-rotating twin screw extruder.

17. The process as claimed in claim 14 further including curing the hydrogel and then drying the cured hydrogel in a controlled manner so as to achieve incomplete drying.

18. The process as claimed in claim 14 further including pre-mixing the reactants to form a pre-mix in a twin screw mixer connected in series with the co-rotating twin screw extruder before passing the reactants through the co-rotating twin screw extruder.

19. The process as claimed in claim 17 including pre-mixing the monomer and the cross linker to form the pre-mix in the twin screw mixer, and then mixing the initiator with the pre-mix in the co-rotating twin screw extruder.

20. The process as claimed in claim 14, wherein the monomer is selected from a group consisting of methacrylic monomers, acrylic monomers, acrylamide monomers and natural source of polymers.

21. The process as claimed in claim 19, wherein the monomer including the natural source of polymers is subjected to a denaturation step prior to mixing with other reactants.
